(19) United States
(12) Patent Application Publication
(10) Pub. No.: US 2012/0107193 A1
(43) Pub. Date: May 3, 2012

(54) TIP PART PIPETTE

(76) Inventors: Vesa Salo, Rajamaki (FI); Ari Jääskeläinen, Helsinki (FI)

(21) Appl. No.: 13/260,431

(22) PCT Filed: Mar. 19, 2010
(86) PCT No.: PCT/FI10/50214

§ 371 Date: Jan. 18, 2012

(30) Foreign Application Priority Data
Mar. 24, 2009 (FI) 20095300

(51) Int. Cl. B01L 3/02

(52) U.S. Cl. 422/501

(57) ABSTRACT

The invention concerns a pipette, which comprises a tip part (1) through which there is an air channel and on the outer end of which a tube-like tip container (2) can be attached with friction joint. The tip part comprises a structure, which at least on the attachment area (8) of the tip container has a surface layer (7) and inside thereof a body part (6) more flexible than the surface layer so that the structure yields when the tip container is attached.

### TECHNICAL FIELD

The invention concerns a pipette which comprises a cylinder and a piston moveable in it and, as an end extension of the cylinder, a tip part, to the end of which a tip container is attached.

### TECHNICAL BACKGROUND

The tip container of a pipette should be attachable to the tip part of the cylinder as tightly as possible so that the joint would not leak air. Leaking naturally makes dosing inaccurate. On the other hand, the tip container should be easily detachable. Usually the tip part is of harder material than the tip container, whereby the tip container yields and sets tightly on the tip. Such pipettes are also known in which the tip part is of softer material than the tip container. Thereby the tip part may be coated with softer material, it may have a sealing ring of softer material, or the tip part may be wholly of softer material. For example, from publication WO 2002/089983 a pipette is known in which the tip part of the cylinder is of softer material than the tip container.

### SUMMARY OF THE INVENTION

Now a pipette according to claim 1 has been invented. Some preferable embodiments of the invention are presented in the other claims.

The structure of the tip part in accordance with the invention has at least on the attachment area of the tip container a surface layer and inside it a body part more flexible than the surface layer so that the structure of the tip part yields when the tip container is attached. With the solution in accordance with the invention the tip container can be attached tightly and reliably with a relatively small force irrespective of the flexibility of the tip container. Respectively, little force is needed for detaching the tip container.

The tip part can be prepared especially from two different polymer materials by injection moulding.

### DESCRIPTION OF THE DRAWINGS

The enclosed drawings are a part of the written description of the invention and represent one pipette in accordance with the invention and a tip container to be attached thereto. In the drawings,

FIG. 1 represents the whole pipette, to which the tip container has been attached,

FIG. 2 represents an enlarged cross section of the tip part of the pipette, and

FIG. 3 represents a more enlarged cross section of the lower end of the tip part, to which the tip container has been attached.

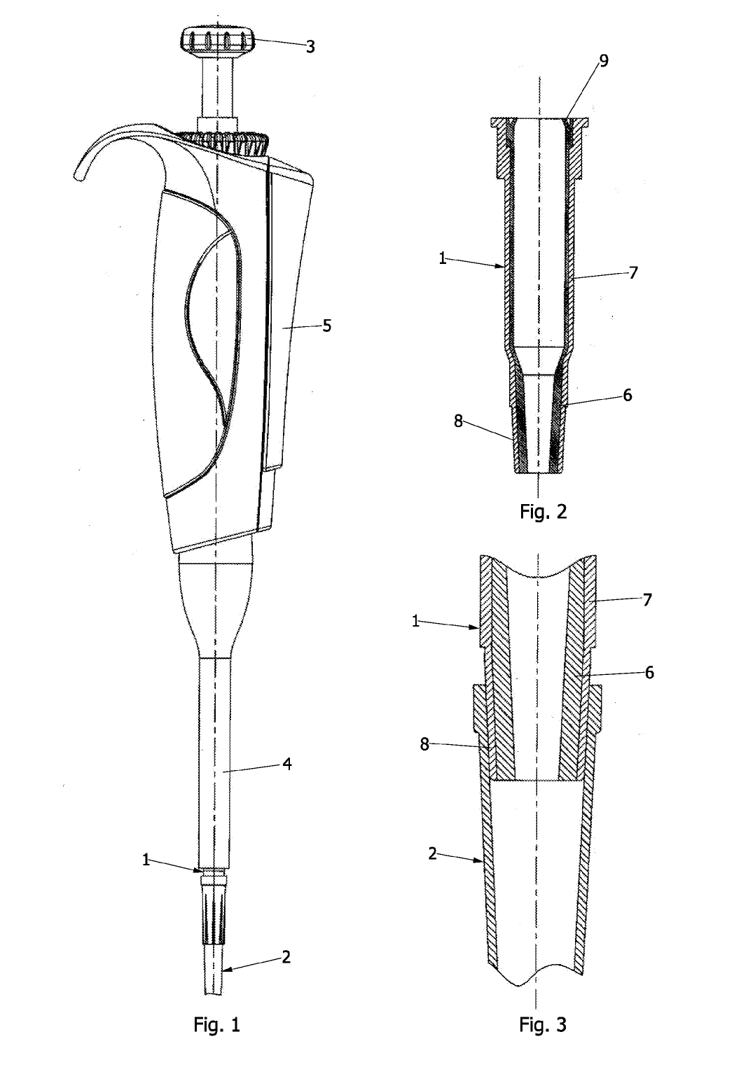

### DETAILED DESCRIPTION OF THE INVENTION

In the pipette in accordance with the invention, there is at least on the attachment area of the tip container a flexible two-layer structure comprising a flexible body part and upon it a surface layer. The body part and the surface layer are preferably joined together permanently. The structure yields when the tip container is attached, and complies with the tip container. In order to achieve this, the surface layer should be sufficiently thin. Also the asymmetries of the tip container and tip part are compensated. Hereby good tightness is achieved already by pressing with a small force. Respectively, a small force is sufficient for detaching the tip container. The body part is preferably of more flexible material than the tip container. The surface layer is preferably thinner than the body part.

As materials, suitable polymer materials are preferably used. The body part is best prepared from suitable elastomer and the cover from harder elastomer or other polymer.

The surface layer may be for example of PVDF, PP, or PA. Its hardness may be for example Shore D 5-80. The body part may be for example of suitable rubber or other elastomer, such as PU, EPDM, nitrile rubber, silicon rubber. Its hardness may be for example Shore A 10-100.

The wear resistance of the surface layer can be made good and the friction small. Due to the hard surface layer, the joint is, however, reliable. Due to the flexibility, a tight joint can be achieved. The tip container does also not attach to the tip part so tightly that the detachment would be difficult. When there are no separate seals in the tip part, it can easily be kept clean. An additional advantage is also that the seal of the piston can be made also at the same time from the same elastic material.

The thickness of the surface layer is for example 0.05-2 mm, preferably 0.5-1 mm. The thickness of the body part is for example 0.5-7 mm, preferably 1-4 mm.

The tip part is preferably prepared from two polymer materials by injection moulding. Especially the so called two component technique may be used, whereby the both layers are moulded simultaneously. The attachment area of the tip part is preferably conical, but it may be even cylindrical.

In the following, an example of the invention is closer presented.

The pipette in accordance with the drawings comprises a cylinder and a piston moveable therein. As an extension of the cylinder there is a tip part 1, through which an aspiration channel leads to the cylinder. A cylindrical tip container 2 is attached to the lower end of the tip part, through the lower end of which tip container liquid is with the piston aspirated into the tip container and removed from it. The piston in the cylinder is moved by the knob 3. Upon the tip part there is a sleeve 4, by means of which the tip container attached to the tip part is pushed off after use. The sleeve is moved by push handle 5.

The tip part 1 comprises a body part 6 and upon it a cover-like surface layer 7, which is of harder material than the body part. The surface layer is on the attachment area 8 of the tip container so thin that it yields when the tip container is attached to its place. Thereby the softer body part also yields respectively. The thickness of the surface layer on the attachment area is preferably 0.5-1 mm and of the body part 1-4 mm.

A lip seal 9 has been made to the upper end of the body part 6 from the material of the body part, with which seal the piston is sealed against the body part.

1.-8. (canceled)

9. A pipette, which comprises
a cylinder and,
as an extension of the cylinder, a tip part through which an air channel leads to the cylinder and on the outer end on its outer surface of which a tube-like tip container can be attached with friction joint, wherein the tip part comprises a structure, which at least on the attachment area of the tip container has a surface layer and inside thereof a body part more flexible than the surface layer so that the structure yields when the tip container is attached.

10. The pipette according to claim 9, wherein the body part is of more flexible material than the tip container.

11. The pipette according to claim 9, wherein the surface layer is thinner than the body part.

12. The pipette according to claim 9, wherein the thickness of the body part is 0.5-7 mm.

13. The pipette according to claim 9, wherein the thickness of the surface layer is 0.05-2 mm.

14. The pipette according to claim 9, wherein the body part and the surface layer are permanently joined together.

15. The pipette according to claim 9, wherein the body part or the surface layer is of polymer material.

16. The pipette according to claim 15, wherein the body part and the surface layer are of polymer material and they have been prepared together by injection moulding.
